(19) United States
(12) Patent Application Publication
(10) Pub. No.: US 2023/0342753 A2
(43) Pub. Date: Oct. 26, 2023

(54) SYSTEMS AND METHODS FOR EVENT-DRIVEN DISPUTE PROCESSING USING DISTRIBUTED LEDGER

(71) Applicant: JPMORGAN CHASE BANK, N.A., New York, NY (US)

(72) Inventors: Jigar GOHIL, Mumbai (IN); Prashant BAJ, Mumbai (IN); Sanjay ARORA, Mira Bhayandar (IN); Vikash KHATRI, Nallasopara East (IN)

(21) Appl. No.: 17/113,937

(22) Filed: Dec. 7, 2020

(30) Foreign Application Priority Data
Oct. 7, 2020 (IN) 202011043581

(51) Int. Cl. G06Q 20/34; G06Q 20/08; G06Q 20/10

(52) U.S. Cl. CPC G06Q 20/341; G06Q 20/0855; G06Q 20/108

(57) ABSTRACT

A method for event-driven dispute processing using distributed ledgers may include: receiving dispute information for a dispute involving a transaction; receiving, from a payment brand and at the distributed ledger, payment brand verification of the dispute information; receiving, from a merchant and at the distributed ledger, transaction details for the transaction; receiving, from the card issuer and at the distributed ledger, chargeback initiation; receiving, from the payment brand and at the distributed ledger, payment brand acceptance of the chargeback; receiving, from the merchant and at the distributed ledger, merchant acceptance of the chargeback; and receiving, from the card issuer and at the distributed ledger, notification of completion of the chargeback.

### RELATED APPLICATIONS

This application claims priority to, and the benefit of, Indian Patent Application No. 202011043581 filed Oct. 7, 2020, the disclosure of which is hereby incorporated, by reference, in its entirety.

### BACKGROUND OF THE INVENTION

### 1. Field of the Invention

Embodiments are generally related to systems and methods for event-driven dispute processing using distributed ledgers.

### 2. Description of the Related Art

Dispute resolution, such as chargebacks, involves the coordination of multiple parties and systems. For example, a dispute/chargeback process in the card and ecommerce payments industry typically involves a card issuer, a payment network (e.g., MasterCard, Visa), acquirers providing merchant services, merchants, and operations vendors (if processes are outsourced). The sheer number of parties often causes processing delays and increases the timeframe for dispute resolution.

### SUMMARY OF THE INVENTION

Systems and methods for event-driven dispute processing using distributed ledgers are disclosed. According to one embodiment, a method for event-driven dispute processing using distributed ledgers may include: (1) receiving, from a card issuer and at a distributed ledger, dispute information for a dispute involving a transaction, the dispute initiated by a cardholder; (2) receiving, from a payment brand and at the distributed ledger, payment brand verification of the dispute information, wherein the payment brand automatically initiates payment brand verification in response to the receipt of the dispute information by the distributed ledger; (3) receiving, from a merchant and at the distributed ledger, transaction details for the transaction, wherein the merchant automatically provides the transaction details to the distributed ledger in response to the receipt of the payment brand verification by the distributed ledger; (4) receiving, from the card issuer and at the distributed ledger, chargeback initiation, wherein the card issuer automatically initiates the chargeback in response to the receipt of the transaction details by the distributed ledger; (5) receiving, from the payment brand and at the distributed ledger, payment brand acceptance of the chargeback, wherein the payment brand automatically initiates acceptance of the chargeback in response to the receipt of the chargeback initiation by the distributed ledger; (6) receiving, from the merchant and at the distributed ledger, merchant acceptance of the chargeback, wherein the merchant automatically initiates acceptance of the chargeback in response to the receipt of payment brand acceptance of the chargeback by the distributed ledger; and (7) receiving, from the card issuer and at the distributed ledger, notification of completion of the chargeback.

In one embodiment, the dispute information may include at least one of cardholder information for the cardholder, an identification of a financial instrument involved in the transaction, an identification of the transaction in dispute, an identifier for the merchant involved in the transaction, an amount in dispute, a date of the transaction, a reason for the dispute, etc.

In one embodiment, the reason may include a reason code.

In one embodiment, the dispute information may be initially received by one of the merchant, the payment brand, and an acquirer for the merchant.

In one embodiment, the payment brand verification may include verification of at least one of a financial instrument involved in the transaction, an identification of the transaction in dispute, the merchant involved in the transaction, an amount in dispute, a date of the transaction, etc.

In one embodiment, the card issuer may provide the transaction details for the transaction to the cardholder in response to the distributed ledger receiving the transaction details for the transaction from the merchant.

In one embodiment, the payment brand may debit an acquirer in response to payment brand acceptance of the chargeback.

In one embodiment, the card issuer may notify the cardholder of the merchant acceptance of the chargeback in response to the distributed ledger receiving merchant acceptance of the chargeback.

In one embodiment, the issuer may credit an account for the cardholder in response to the distributed ledger receiving merchant acceptance of the chargeback.

According to another embodiment, a system for event-driven dispute processing using distributed ledgers may include a distributed ledger network including a card issuer node for a card issuer; a merchant node for a merchant; and a payment network node for a payment network. The card issuer may write dispute information for a dispute involving a transaction to the distributed ledger via the card issuer node, the dispute initiated by a cardholder; the payment brand node may detect the dispute information on the distributed ledger and may write payment brand verification of the dispute information to the distributed ledger; the merchant node may detect the payment brand verification on the distributed ledger and may write transaction details for the transaction to the distributed ledger in response to the receipt of the payment brand verification by the distributed ledger; the card issuer node may detect the transaction details on the distributed ledger and may write chargeback initiation on the distributed ledger; the payment brand node may detect the chargeback initiation on the distributed ledger and may write payment brand acceptance of the chargeback to the distributed ledger; the merchant node may detect payment brand acceptance of the chargeback on the distributed ledger and may write merchant acceptance of the chargeback to the distributed ledger; and the card issuer node completes the chargeback in response to merchant acceptance of the chargeback on the distributed ledger and may write notification of completion of the chargeback to the distributed ledger.

In one embodiment, the dispute information may include at least one of cardholder information for the cardholder, an identification of a financial instrument involved in the transaction, an identification of the transaction in dispute, an identifier for the merchant involved in the transaction, an amount in dispute, a date of the transaction, a reason for the dispute, etc.

In one embodiment, the reason may include a reason code.

In one embodiment, the dispute information may be initially received by one of the merchant, the payment brand, and an acquirer for the merchant.

In one embodiment, the payment brand verification may include verification of at least one of a financial instrument involved in the transaction, an identification of the transaction in dispute, the merchant involved in the transaction, an amount in dispute, a date of the transaction, etc.

In one embodiment, the card issuer may provide the transaction details for the transaction to the cardholder in response to the distributed ledger receiving the transaction details for the transaction from the merchant.

In one embodiment, the payment brand may debit an acquirer in response to payment brand acceptance of the chargeback.

In one embodiment, the card issuer may notify the cardholder of the merchant acceptance of the chargeback in response to the distributed ledger receiving merchant acceptance of the chargeback.

In one embodiment, the issuer may credit an account for the cardholder in response to the distributed ledger receiving merchant acceptance of the chargeback.

In one embodiment, the system may further include an acquirer node for the acquirer.

In one embodiment, the system may further include a third party service provider node for a third party chargeback processor, and the third-party chargeback processor may execute the chargeback.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for event-driven dispute processing using a distributed ledger according to one embodiment; and

FIG. 2 illustrates a method for event-driven dispute processing using a distributed ledger according to one embodiment.

### DETAILED DESCRIPTION OF PREFERRED EMBODIMENTS

Embodiments are directed to systems and methods for event-driven dispute processing using distributed ledgers. For example, embodiments may leverage the use of distributed ledgers, smart contracts, and supporting technologies to initiate and resolve dispute. Embodiments may address issues in the dispute/chargeback processing and related reconciliation processes.

In embodiment, visibility in dispute/chargeback process flow may be accomplished at a “batch” or “real time system interface” level using, for example, one or more smart contract deployed on a distributed ledger (e.g., a Blockchain-based ledger) that enables event-driven processing. Embodiments reduce the overhead and inefficiencies associated with transaction level reporting and reconciliation with multiple participants, and may minimize errors and resulting financial losses.

Embodiments may include a distributed ledger network including a card issuer, a payment network, an acquirer, one or more merchant, and operations vendors as needed. The distributed ledger network may be a private distributed ledger network. Examples of distributed ledger networks include any suitable distributed network that may implement smart contracts, including Ethereum, Quorum, Hyperledger Fabric, Hyperledger Sawtooth, etc. The network governance may be based on the mutual agreements within the participating stakeholders.

Embodiments may use smart contracts, which may hold business logic, to record the transactions on the distributed ledger. There may be one or more smart contracts, which may be depend on an agreement among the participants. Examples include a dispute smart contract and a chargeback smart contract.

Dispute smart contracts may be used to place and retrieve the initial dispute data in the overall process, such as when a cardholder disputes a specific transaction due to fraud, a good or service that was not provided, etc. The dispute may or may not result in a chargeback. The dispute may be processed using a smart contract that is written to the distributed ledger with original credit/debit card transaction details, along with any actions taken by the card issuer and payment brand during dispute processing (e.g., dispute initiated, dispute accepted by payment brand, chargeback initiated, etc.). The dispute contract generates and listens to events;

Chargeback smart contracts may be to place and retrieve transaction data in the process. The chargeback contract may include the posting of the initial chargeback along with related disputed original transaction data, actions taken by all the parties involved during the disputes processing (e.g., chargeback initiated, chargeback accepted, chargeback represented, returned to merchant, merchant recourse requested, merchant recourse accepted, etc.). The chargeback contract may generate and listens to events, and external systems, devices, and other smart contracts may consume the events. For example, if there are settlement/funding transactions happening on the same distributed ledger network, a new settlement contract may be initialized to perform the same chargeback-related financial movement.

There may be several types of chargeback smart contracts depending on the agreement among the parties. For example, a traditional chargeback smart contract may function in the traditional manner in which all parties can initiate transactions with different type of actions. Another chargeback smart contract may provide a platform for the merchant and issuer to resolve the dispute with limited interaction from other parties. Any other suitable chargeback smart contract may be used as is necessary and/or desired.

In embodiments, the infrastructure disclosed herein facilitates the typical four or five party chargeback process (e.g., issuer, acquirer, payment brand, merchant, and an optional third-party charge back processor) as well as different patterns, where one or more of the typical chargeback parties may act as observers to the chargeback process. For example, smart contact(s) may perform the activities of a typical chargeback party by implementing logic that the typical chargeback party would apply. In one embodiment, machine learning and/or artificial intelligence may be used to learn the participant's procedures and preferences.

In one embodiment, only the issuer may actively participate in the chargeback process, and the other parties may participate as observers using smart contracts.

In one embodiment, each party may determine whether to actively participate or to participate as an observer (e.g., using smart contracts) based on a value of a chargeback, an identification of the underlying good or service, or any other basis as is necessary and/or desired.

Embodiments may further include one or more distributed application (“DApp) that may serve the front end/reporting needs for each participant. The DApp may be an application written in any suitable programming language that helps connecting to distributed ledger network, send transactions, access smart contract functions, listen to distributed ledger events, and translate data for respective use. In embodiments, the DApp may exist on a node or a cluster of nodes within an organization.

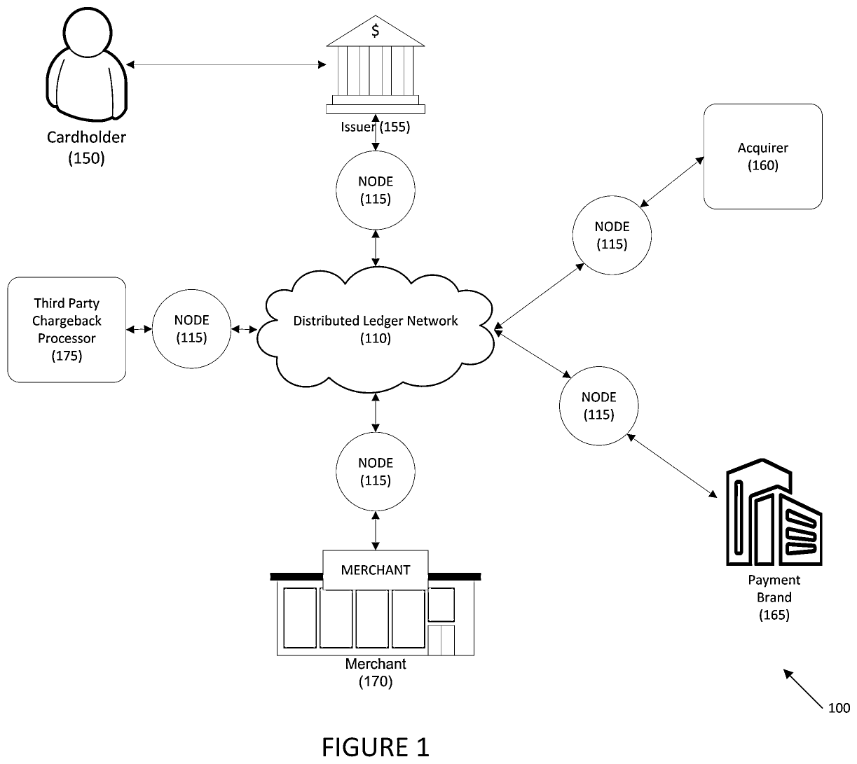

Referring to FIG. 1, a system for event-driven dispute processing is disclosed according to an embodiment. System 100 may include distributed ledger network 110, which may be a blockchain-based distributed ledger network. Examples include Ethereum, Quorum, Hyperledger Fabric,

Hyperledger Sawtooth, etc. Other distributed ledger technologies may be used as is necessary and/or desired.

Network 110 may include a plurality of nodes 115. In one embodiment, each participant (e.g., cardholder 150, issuer 155, acquirer 160, payment brand 165, merchant 170, and third-party chargeback processor 175) may each be associated with a node 115.

Each node 115 may execute one or more smart contact.

Network 115 may facilitate communication among a plurality of participants, such as cardholder 150, issuer 155, acquirer 160, payment brand 165, merchant 170, and third-party chargeback processor 175. Each participant may maintain a copy of the distributed ledger.

In one embodiment, one or more of the participants may access distributed ledger network 110 using, for example, an API instead of node 115.

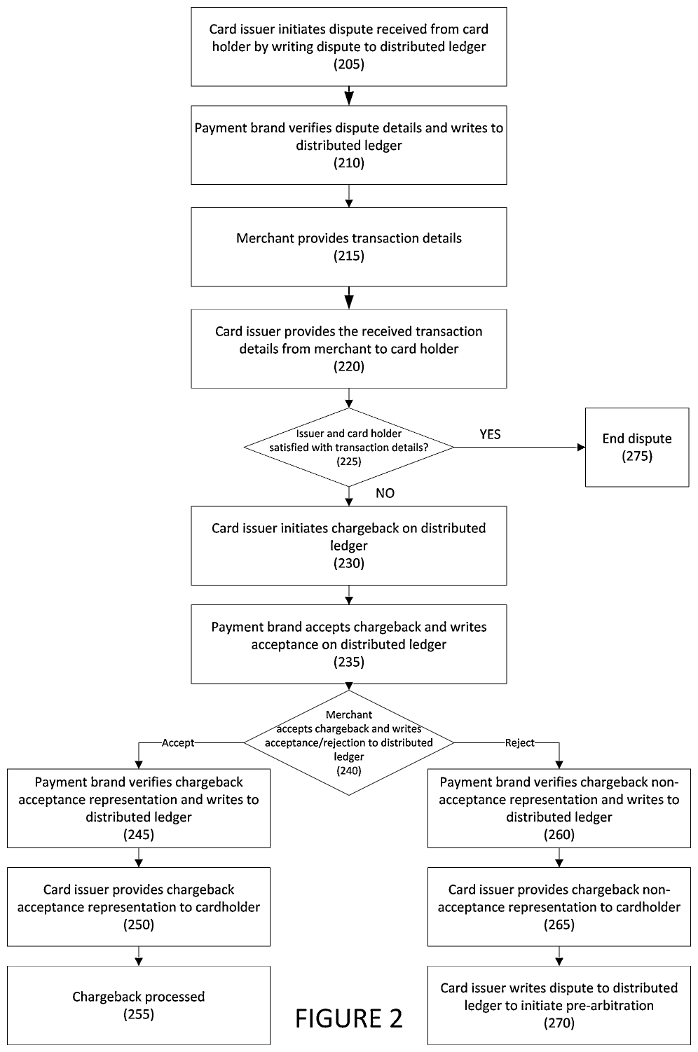

Referring to FIG. 2, a method for event-driven dispute processing is disclosed according to an embodiment.

In step 205, a card issuer may receive a dispute from a cardholder, and may initiate the dispute by committing dispute information to the distributed ledger at its node. In one embodiment, the nodes may implement a consensus model and may then write the dispute information to the distributed ledger as a block.

In one embodiment, the dispute information may include cardholder information, the financial instrument involved in the transaction, the transaction in question, the merchant involved in the transaction, the amount in dispute, the date of the transaction, and a reason (e.g., a reason code) for the dispute.

In addition, identifiers associated with the parties involved, such as an acquirer reference number, an acquirer Bank Identification Number (BIN)/Interbank Card Association (ICA) number, an issuer BIN/ICA, may be included as is necessary and/or desired.

In step 210, the payment brand's node may detect the dispute on the distributed ledger and may initiate payment brand verification of the dispute information. For example, the payment brand may verify one or more of the elements of the transaction information, such as the financial instrument involved in the transaction, the transaction in question, the merchant involved in the transaction, the amount in dispute, and the date of the transaction.

After verification, the payment brand may submit the verification to its node, which may write the verification to the distributed ledger.

In step 215, the merchant's node may detect the verification on the distributed ledger, and the merchant may provide transaction details for the transaction.

In step 220, the card issuer's node may detect the merchant's writing of the transaction details to the distributed ledger, and the card issuer may then provide the merchant's transaction details to the cardholder. This may be performed off-chain.

In step 225, if the issuer and the cardholder are satisfied with the merchant's response to the point where the cardholder no longer wishes to pursue the dispute, in step 275, the cardholder may end the dispute. In one embodiment, the issuer may write this to the distributed ledger.

If the issuer and the cardholder are not satisfied with the merchant's response and wish to continue the dispute, the issuer may write this to the distributed ledger. In step 230, the issuer may initiate a chargeback by writing the chargeback to the distributed ledger.

In addition, identifiers associated with the parties involved, such as an acquirer reference number, an acquirer BIN/ICA, an issuer BIN/ICA, may be included as is necessary and/or desired.

In step 235, the payment brand's node may detect the chargeback on the distributed ledger, and may accept the chargeback and may write acceptance of chargeback to the distributed ledger. For example, the payment brand may approve the chargeback and debits the acquirer, giving the benefit of the doubt to card holder.

In step 240, the merchant's node may detect the acceptance of the chargeback by the payment brand, and may accept or reject the chargeback. It may then write the acceptance or rejection to the distributed ledger.

If the merchant accepts the chargeback, in step 245, the payment brand's node may detect the acceptance on the distributed ledger, and the payment brand may verify the acceptance. The payment brand may write verification to the distributed ledger.

In step 250, the card issuer's node may detect the acceptance on the distributed ledger, and the card issuer may then notify the cardholder of the acceptance. This may occur off-chain.

In step 255, the card issuer may then process the chargeback by, for example, crediting the cardholder's account, receiving funds from the merchant, etc. The card issuer may then write the completion of the chargeback to the distributed ledger.

If, in step 240, the merchant does not accept the chargeback, in step 260, the payment brand's node may detect the rejection on the distributed ledger, and the payment brand may verify the rejection. The payment brand may write verification to the distributed ledger.

In step 265, the card issuer's node may detect the verification on the distributed ledger, and the card issuer may then notify the cardholder of the rejection. This may occur off-chain.

The card issuer and the cardholder may reject the merchant's rejection and may write that to the distributed ledger.

In step 270, the card issuer may then write the dispute to the distributed ledger to initiate pre-arbitration. In one embodiment, additional documents and the basis for pre-arbitration may be included.

The method of FIG. 2 depicts a process in which the dispute is processed without any issues, such as denials, missing information, etc. Any deviations from the method may be handled by, for example, application logic in smart contracts. For example, if a transaction retrieval request is declined or expired, a smart contract may implement logic that resolves the issue.

Although several embodiments have been disclosed, it should be recognized that these embodiments are not exclusive to each other, and certain elements or features from one embodiment may be used with another.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for event-driven dispute processing using distributed ledgers, comprising:
receiving, from a card issuer and at a distributed ledger, dispute information for a dispute involving a transaction, the dispute initiated by a cardholder;
receiving, from a payment brand and at the distributed ledger, payment brand verification of the dispute information, wherein the payment brand automatically initiates payment brand verification in response to the receipt of the dispute information by the distributed ledger;
receiving, from a merchant and at the distributed ledger, transaction details for the transaction, wherein the merchant automatically provides the transaction details to the distributed ledger in response to the receipt of the payment brand verification by the distributed ledger;
receiving, from the card issuer and at the distributed ledger, chargeback initiation, wherein the card issuer automatically initiates the chargeback in response to the receipt of the transaction details by the distributed ledger;
receiving, from the payment brand and at the distributed ledger, payment brand acceptance of the chargeback, wherein the payment brand automatically initiates acceptance of the chargeback in response to the receipt of the chargeback initiation by the distributed ledger;
receiving, from the merchant and at the distributed ledger, merchant acceptance of the chargeback, wherein the merchant automatically initiates acceptance of the chargeback in response to the receipt of payment brand acceptance of the chargeback by the distributed ledger; and
receiving, from the card issuer and at the distributed ledger, notification of completion of the chargeback.

2. The method of claim 1, wherein the dispute information comprises at least one of cardholder information for the cardholder, an identification of a financial instrument involved in the transaction, an identification of the transaction in dispute, an identifier for the merchant involved in the transaction, an amount in dispute, a date of the transaction, and a reason for the dispute.

3. The method of claim 2, wherein the reason comprises a reason code.

4. The method of claim 1, wherein the dispute information is initially received by one of the merchant, the payment brand, and an acquirer for the merchant.

5. The method of claim 1, wherein the payment brand verification comprises verification of at least one of a financial instrument involved in the transaction, an identification of the transaction in dispute, the merchant involved in the transaction, an amount in dispute, and a date of the transaction.

6. The method of claim 1, wherein the card issuer provides the transaction details for the transaction to the cardholder in response to the distributed ledger receiving the transaction details for the transaction from the merchant.

7. The method of claim 1, wherein the payment brand debits an acquirer in response to payment brand acceptance of the chargeback.

8. The method of claim 1, wherein the card issuer notifies the cardholder of the merchant acceptance of the chargeback in response to the distributed ledger receiving merchant acceptance of the chargeback.

9. The method of claim 1, wherein the issuer credits an account for the cardholder in response to the distributed ledger receiving merchant acceptance of the chargeback.

10. A system for event-driven dispute processing using distributed ledgers, comprising:
a distributed ledger network comprising:
a card issuer node for a card issuer;
a merchant node for a merchant; and
a payment network node for a payment network;
wherein:
the card issuer writes dispute information for a dispute involving a transaction to the distributed ledger via the card issuer node, the dispute initiated by a cardholder;
the payment brand node detects the dispute information on the distributed ledger and writes payment brand verification of the dispute information to the distributed ledger;
the merchant node detects the payment brand verification on the distributed ledger and writes transaction details for the transaction to the distributed ledger in response to the receipt of the payment brand verification by the distributed ledger;
the card issuer node detects the transaction details on the distributed ledger and writes chargeback initiation on the distributed ledger;
the payment brand node detects the chargeback initiation on the distributed ledger and writes payment brand acceptance of the chargeback to the distributed ledger;
the merchant node detects payment brand acceptance of the chargeback on the distributed ledger and writes merchant acceptance of the chargeback to the distributed ledger; and
the card issuer node completes the chargeback in response to merchant acceptance of the chargeback on the distributed ledger and writes notification of completion of the chargeback to the distributed ledger.

11. The system of claim 10, wherein the dispute information comprises at least one of cardholder information for the cardholder, an identification of a financial instrument involved in the transaction, an identification of the transaction in dispute, an identifier for the merchant involved in the transaction, an amount in dispute, a date of the transaction, and a reason for the dispute.

12. The system of claim 11, wherein the reason comprises a reason code.

13. The system of claim 10, wherein the dispute information is initially received by one of the merchant, the payment brand, and an acquirer for the merchant.

14. The system of claim 10, wherein the payment brand verification comprises verification of at least one of a financial instrument involved in the transaction, an identification of the transaction in dispute, the merchant involved in the transaction, an amount in dispute, and a date of the transaction.

15. The system of claim 10, wherein the card issuer provides the transaction details for the transaction to the cardholder in response to the distributed ledger receiving the transaction details for the transaction from the merchant.

16. The system of claim 10, wherein the payment brand debits an acquirer in response to payment brand acceptance of the chargeback.

17. The system of claim 10, wherein the card issuer notifies the cardholder of the merchant acceptance of the chargeback in response to the distributed ledger receiving merchant acceptance of the chargeback.

18. The system of claim 10, wherein the issuer credits an account for the cardholder in response to the distributed ledger receiving merchant acceptance of the chargeback.

19. The system of claim 13, wherein the distributed ledger network further comprises:
an acquirer node for the acquirer.

20. The system of claim 13, wherein the distributed ledger network further comprises:
a third party service provider node for a third party chargeback processor, wherein the third-party chargeback processor executes the chargeback.
